(19) United States
(12) Patent Application Publication
(10) Pub. No.: US 2006/0219893 A1
(43) Pub. Date: Oct. 5, 2006

(54) Apparatus and method for detecting threats

(76) Inventors: Ken Nishihira, Yokohama (JP); Kageyoshi Katakura, Tokyo (JP); Shigeru Honjo, Ohtsuki-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/271,977

(22) Filed: Nov. 14, 2005

(30) Foreign Application Priority Data
Nov. 12, 2004 (JP) 2004-328995

(51) Int. Cl. B01D 59/44; H01J 49/00

(52) U.S. Cl. 250/288; 250/284

(57) ABSTRACT

A standard mass chromatogram which a substance to be detected exhibits is provided as a database within an apparatus. A measured mass chromatogram obtained by measurement and the standard mass chromatogram stored in the database are compared with each other after their standardization to determine the degree of coincidence of the two. Then, by utilizing the degree of coincidence, it is determined whether the substance to be detected has been detected or not. Further, two ions are selected from among plural ions derived from the substance to be detected and correlation between mass chromatograms of the two selected ions is compared with correlation between mass chromatograms of the two selected ions stored in the database to determine the degree of coincidence of the two. This degree of coincidence is also utilized for determining whether the substance to be detected has been detected or not.

### CLAIM OF PRIORITY

The present application claims priority from Japanese patent application serial no. 2004-328995, filed on Nov. 11, 2004, the content of which is hereby incorporated by reference into this application.

### BACKGROUND OF THE INVENTION

The present invention relates to an apparatus for detecting threats and method of detecting threats wherein, after a test sample is vaporized, vaporized gas molecules are ionized and the resulting ions are subjected to mass spectrometric analysis to determine whether or not a component to be detected such as, for example, an explosive or a prohibited drug is contained within the test sample.

With the simultaneous terrorist attacks in the U.S. as a decisive turning-point, security in various important facilities such as airports has been being strengthened. Particularly, as to an apparatus for detecting traces of such articles as explosives and prohibited drugs (hereinafter referred to generically as “threats”) adhered to baggage or the like, there is known an apparatus wherein a sample obtained by wiping baggage is vaporized by heating, then vaporized gas molecules are ionized using an ion source disposed in a subsequent stage and the resulting ions are subjected to mass spectrometric analysis. For example, an apparatus disclosed in JP-A No. 2004-212073 is known as an apparatus for detecting threats having such a sample introducing method. U.S. Pat. No. 6,884,997 B2 is a counterpart of JP-A No. 2004-212073.

In the apparatus for detecting threats disclosed in JP-A No. 2004-212073 there is adopted an SIM (Selected Ion Monitoring) method in which one or plural ions derived from a substance to be detected are selected and a change with time (mass chromatogram) of ionic strength for the selected ion(s) is obtained by mass spectrometric analysis. This apparatus for detecting threats determines whether a substance to be detected is contained or not in a test sample. Therefore, on the basis of which is the larger between a peak height of each of mass chromatograms of the selected ions and a preset threshold value, it is determined whether the substance to be detected has been detected or not.

On the other hand, in U.S. Pat. No. 5,119,315 there is disclosed a method wherein a degree of coincidence between a chromatogram which has been measured over a relatively long time (several minutes to several ten minutes) by for example gas chromatography/mass spectrometer (GC/MS) and a chromatogram preregistered in a database is determined and is used as a criterion for specifying a sample.

With only the comparison between a maximum signal value and a threshold value which is conducted in JP-A No. 2004-212073, it is insufficient for improving the detecting performance for a substance to be detected and for distinction between a substance to be detected and a substance not to be detected. There arise problems such as false information and alarm leakage.

In U.S. Pat. No. 5,119,315, a mass chromatogram measured by GC/MS is compared with a standard mass chromatogram pre-registered in a database. In this method, however, the identification of a sample is performed by reference to plural peaks on a mass chromatogram measured over a long time. Thus, under conditions such that the measurement time is short and there is obtained only one peak at most for each selected ion, it is difficult to use the method disclosed in the above U.S. Pat. No. 5,119,315.

### SUMMARY OF THE INVENTION

According to the present invention there is provided an apparatus and method for detecting threats which permit the adoption of a short measurement time and can distinguish between a substance to be detected and other substances with a high accuracy.

In the present invention, a substance adhered to a wiping sheet is vaporized, then vaporized gas molecules are ionized and the resulting ions are subjected to mass spectrometric analysis, and a measured mass chromatogram of a mass-to-charge ratio obtained from the adhered substance and a standard chromatogram having the same mass-to-charge ratio are compared with each other using a database which stores standard mass chromatograms of plural ions derived from threats, to determine a degree of coincidence between the measured mass chromatogram and the standard mass chromatogram.

### BRIEF DESCRIPTION OF THE DRAWINGS

Preferred embodiments of the present invention will now be described in conjunction with the accompanying drawings, in which:

FIG. 1 illustrates a state of operation of an apparatus 15 for detecting threats embodying the present invention;

FIG. 2 is a block diagram of the apparatus for detecting threats;

FIG. 3 illustrates measured data and a method of obtaining mass chromatograms from the measured data;

FIG. 4 is a block diagram of a measurement processing computer and peripheral devices;

FIG. 5 is a standard mass chromatogram registered in a database;

FIG. 6 illustrates a threat detection processing flow;

FIGS. 7A and 7B illustrate fitting parameters;

FIG. 8 illustrates a function α (alpha);

FIGS. 9A to 9G illustrate a function β (beta);

FIG. 10 illustrates a case where a mass chromatogram of a selected ion is correlated with a mass chromatogram of oxygen ion;

FIGS. 11A and 11B illustrate a setting relation between a mass-to-charge ratio and coefficients p. q; and

FIGS. 12A and 12B illustrate an effect obtained.

### DESCRIPTION OF THE PREFERRED EMBODIMENT

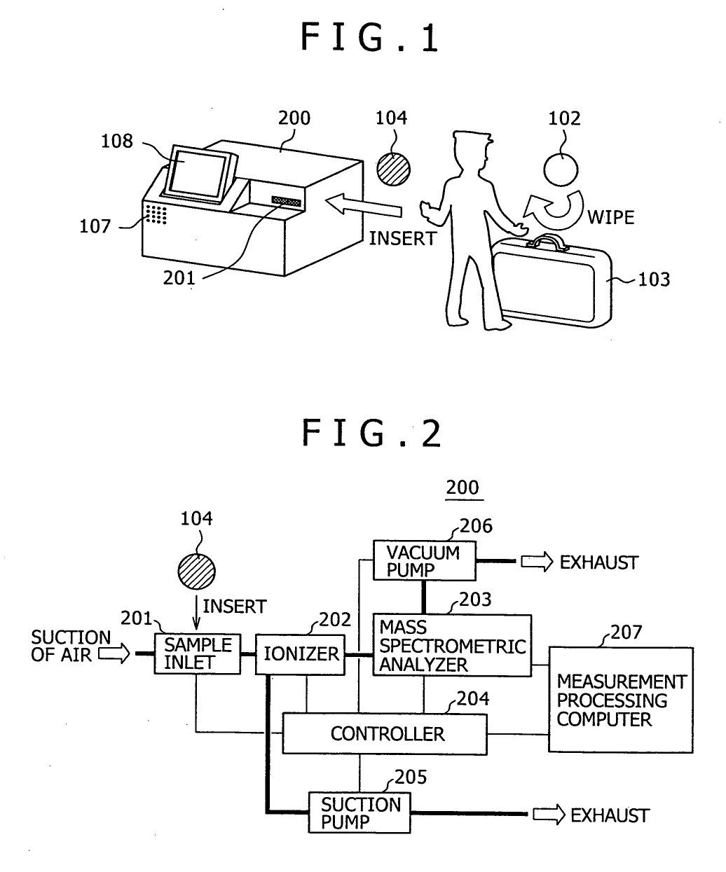

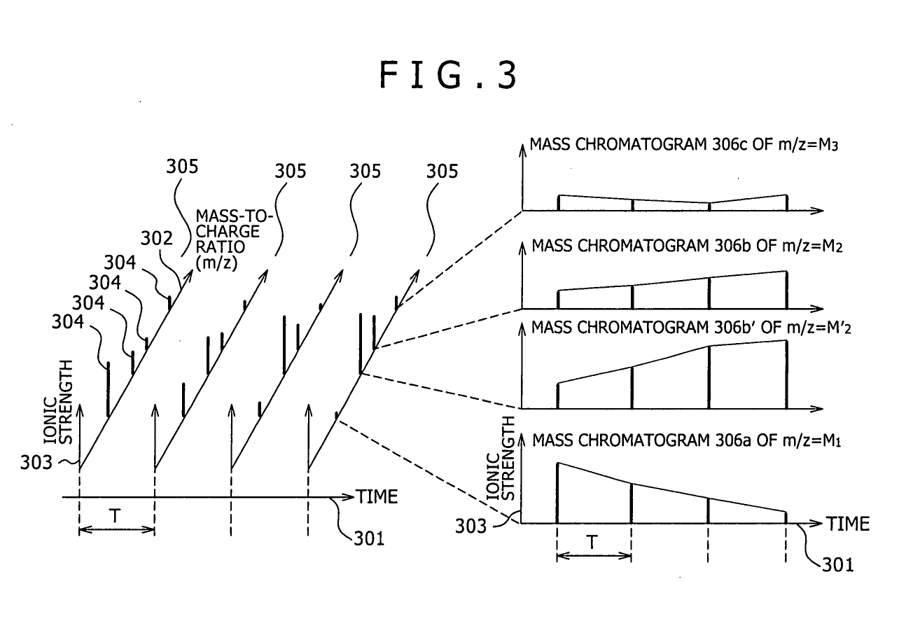

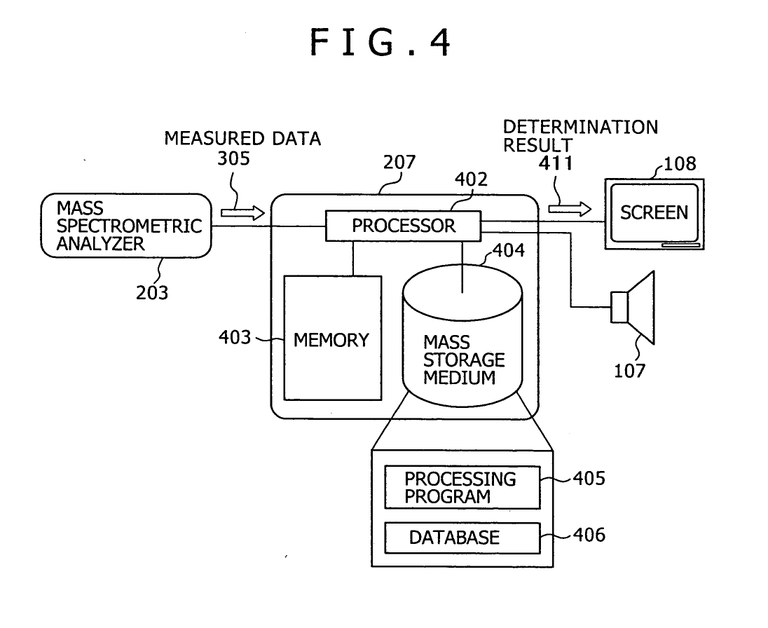

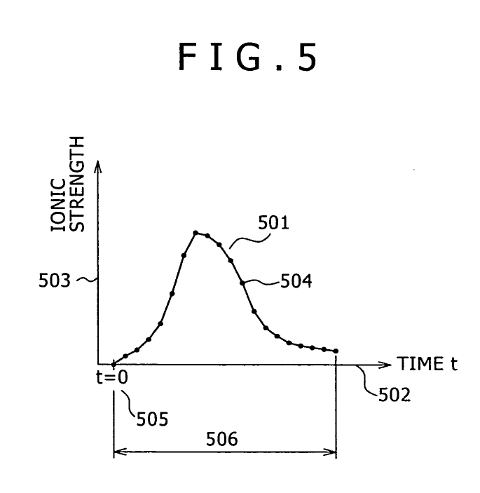

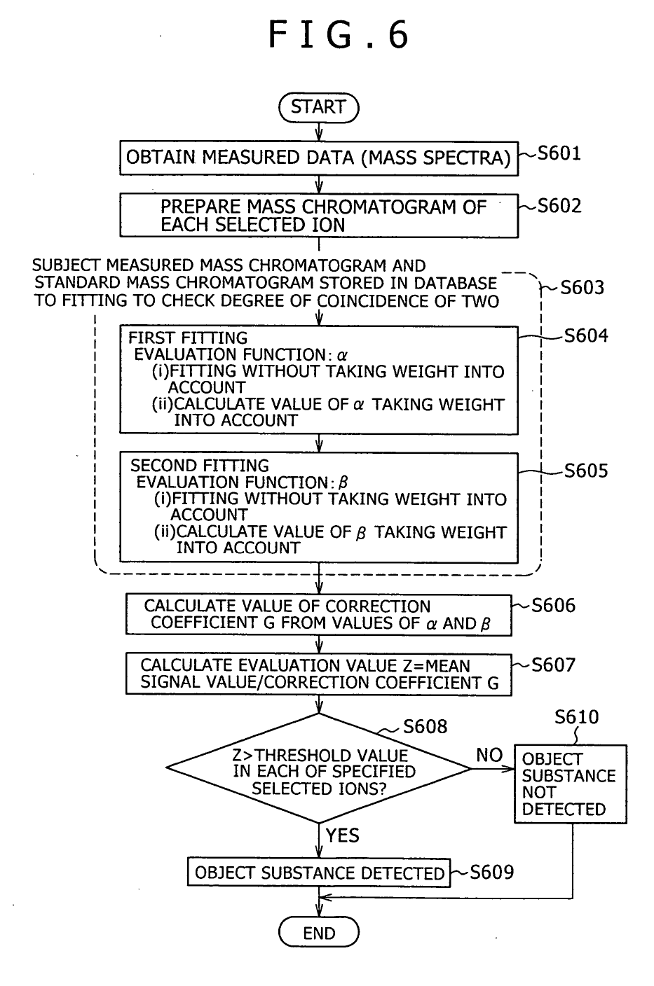

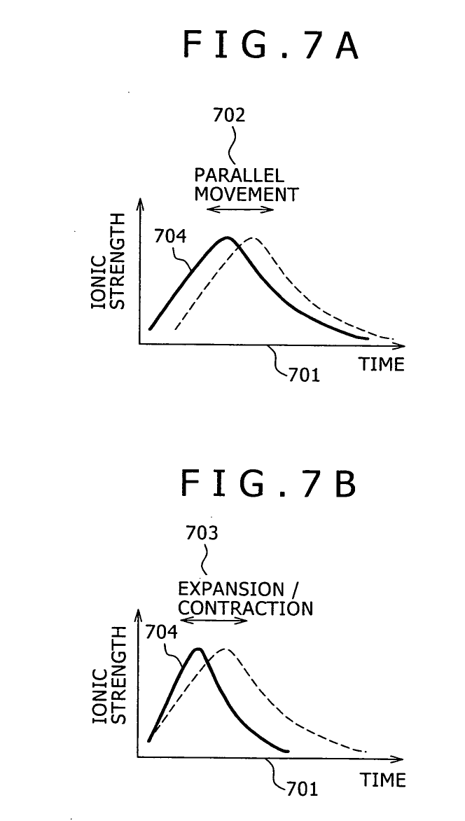

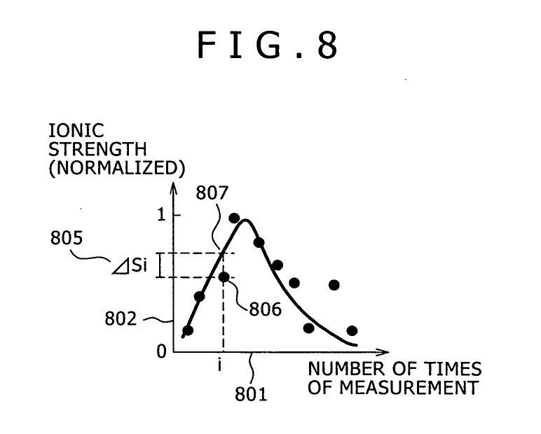

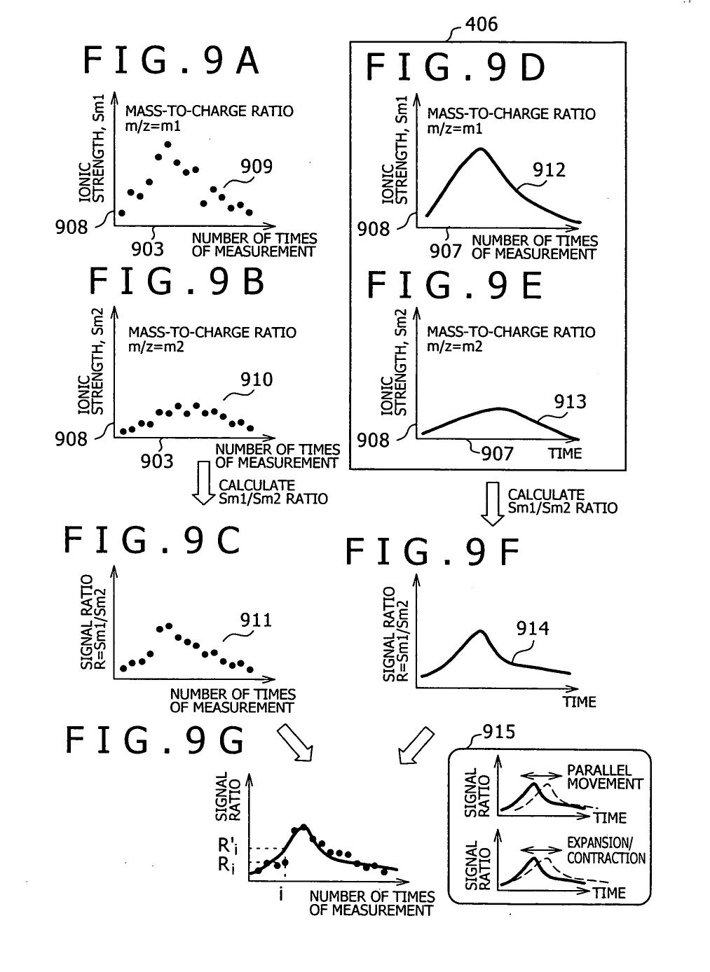

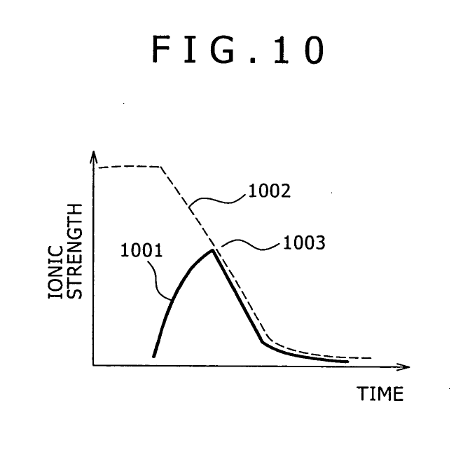

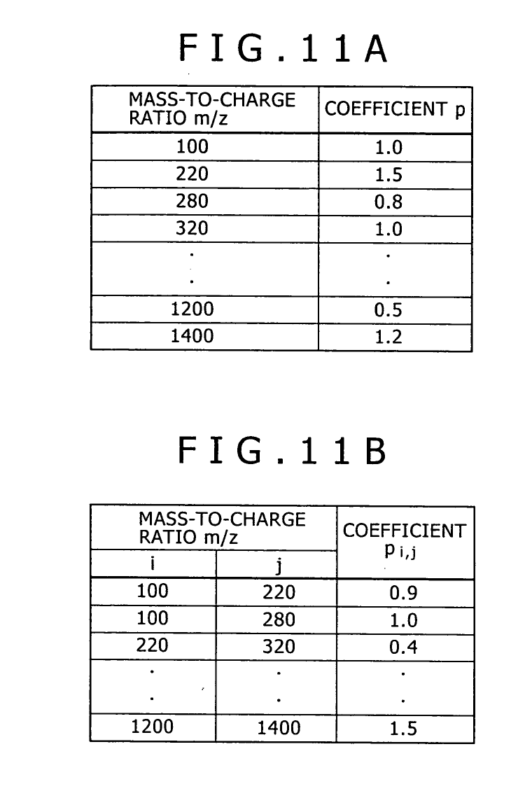

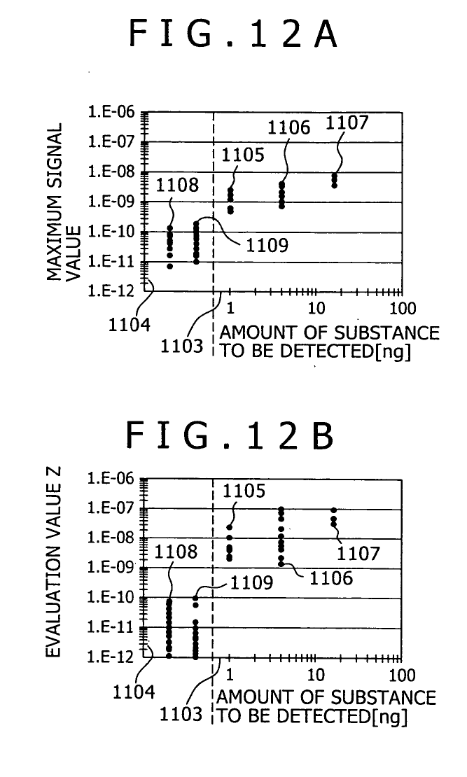

An embodiment of the present invention will be described hereunder with reference to the accompanying drawings, in which FIG. 1 illustrates a state of operation of an apparatus for detecting threats embodying the present invention, FIG. 2 is a block diagram of the apparatus for detecting threats embodying the present invention, FIG. 3 illustrates measured data and a method of obtaining mass chromatograms from the measured data embodying the present invention, FIG. 4 is a block diagram of a measurement processing computer and peripheral devices embodying the present invention, FIG. 5 is a standard mass chromatogram registered in a database embodying the present invention, FIG. 6 illustrates a threat detection processing flow embodying the present invention, FIG. 7 illustrates fitting parameters embodying the present invention, FIG. 8 illustrates a function α embodying the present invention, FIG. 9 illustrates a function β embodying the present invention, FIG. 10 illustrates a case where a mass chromatogram of a selected ion is correlated with a mass chromatogram of oxygen ion, FIG. 11 illustrates a setting relation between a mass-to-charge ratio and coefficients p, q embodying the present invention, and FIG. 12 illustrates an effect obtained, embodying the present invention.

First, with reference to FIG. 1, a description will be given about a method of operation of the apparatus. An inspector wipes a part (mainly a handle) of baggage 103 with use of a wiping sheet 102. A test sample 104 adheres to the wiped surface of the sheet 102. The inspector places the sheet 102 on a heating tray (not shown) and inserts the heating tray into a sample inlet 201 of an apparatus 200 for detecting threats embodying the present invention. The apparatus 200 for detecting threats performs mass spectrometric analysis and detection of a threat for the test sample 104 in accordance with a procedure which will be described later. As a result, if a substance to be detected which is specified beforehand in terms of a mass-to-charge ratio, e.g., an explosive or a prohibited drug, is detected, an alarm is issued by a speaker 107 and the substance to be detected is displayed on a screen of a display 108. Tact time during this period is about 10 seconds.

The configuration of the apparatus 200 for detecting threats will now be described with reference to FIG. 2. The apparatus 200 for detecting threats is made up of the sample inlet 201, an ionizer 202, a mass spectrometric analyzer 203, a controller 204, a suction pup 205, a vacuum pump 206, and a measurement processing computer 207. Thick solid lines in the figure represent pipes for the flow of gas therethrough, while thin solid lines represent electric wiring through which control signals and measured data are transmitted.

The test sample 104 thus introduced into the sample inlet 201 is heated by a heater (not shown), so that sample molecules are vaporized and the vaporized molecules are carried to the ionizer 202 by an air flow created by the suction pump 205. Some of the vaporized molecules are ionized by corona discharge in the ionizer 202. The resulting ions are moved by an electric field to the mass spectrometric analyzer 203 disposed in a subsequent stage and are subjected to mass spectrometric analysis therein. The mass spectrometric analyzer 203 is reduced its pressure by the vacuum pump 206 because it is required to be kept in a state of a high vacuum. Measured data obtained in the mass spectrometric analyzer 203 is subjected to a predetermined processing in the measurement processing computer 207 to determine whether a substance to be detected is contained or not in the test sample 104. The result of the determination is reported to the apparatus user through a screen and a speaker (neither shown). The supply voltage in each constituent section: is controlled by the measurement processing computer 207 via the controller 204.

As a method for the mass spectrometric analysis in the mass spectrometric analyzer 203, there is adopted a method wherein the value of a detected signal varies with measurement time. In this apparatus there is used a quadruple mass spectrometer. In this case, in the mass spectrometric analyzer 203, the internal voltage is swept with a predetermined period T so as to detect ions in plural preselected mass-to-charge (m/z) ratios. In this connection there is used an SIM method wherein the selected ions are ions (e.g., a parent ion and a fragment ion thereof (resulting from decomposition of the parent ion)) peculiar to the substance to be detected and an ion (e.g., oxygen ion) which identifies the soundness of the apparatus.

A description will now be,given of measured data with reference to FIG. 3. In the same figure, numeral 301 denotes a time base, numeral 302 denotes an axis of a mass-to-charge ratio (m/z), and numeral 303 denotes an ionic strength (signal value). In the mass spectrometric analyzer 203, measurement is made for each of selected ions (the number of selected ions in FIG. 3 is four) at every period T. Consequently, as shown in the figure, mass spectra 305 including components 304 of selected ions are obtained plurally at every period T. Further, if the selected ion components 304 in the mass spectra 304 are joined together in time series, there can be obtained mass chromatograms 306a (m/z=M₁), 306b (m/z=M₂), 306b′ (m/z=M₂′), and 306c (m/z=M₃), correspondingly to the selected ions. M₁ to M₃ are in a relation of M₁<M₂′<M₂<M₃.

Among the plural selected ions there are those derived from a common substance. Correlation is generally recognized between mass chromatograms of selected ions derived from a common substance. Among the four mass chromatograms 306a, 306b, 306b′, and 306c shown in FIG. 3, 306b and 306b′ are selected ions derived from a common substance, 306b is a parent ion and 306b′ is a fragment ion. On the other hand, 306a and 306c are derived respectively from independent selected ions.

The configuration of the measurement processing computer 207 will now be described in detail with reference to FIG. 4. The measurement processing computer 207 includes a processor 402, a memory 403, and a mass storage medium 404, which components are connected by electric wiring indicated with solid lines and an interface (not shown). A processing program 405 which defines a measurement processing procedure and a data processing procedure and a database 406 which describes information on the substance to be detected and coefficient to be described later are stored on the mass storage medium 404 which is constituted by a hard disc. Further, the processor 402 is connected through an interface (not shown) to the mass spectrometric analyzer 203, display 108, speaker 107 and input means (not shown) which components are located outside the measurement processing computer 207.

Upon start-up of the apparatus 200 for detecting threats, the processing program 405 and the database 406 both stored on the mass storage medium 404 are read into the memory 403 and the processor 402 performs the following measurement processing and data processing. The data 305 measured by the mass spectrometric analyzer 203, (mass spectra in the measurements), are stored through an interface (not shown) into the memory 403 and the mass storage medium 404 both provided in the measurement processing computer 207. After the end of measurement, such mass chromatograms for the selected ions as shown in FIG. 3 are prepared in accordance with the processing program 405.

The mass chrograms for the selected ions are again stored in the memory 403 and the mass storage medium 404. In accordance with a determination processing to be described later it is determined whether the substance to be detected is present or not, and a determination result 411 is displayed on the screen of the display 108 through an interface (not shown). When the substance (threat) to be detected is detected by the determination processing, not only the determination result 411 is displayed on the screen, but also the speaker 107 is driven through an interface (not shown) to sound an alarm.

A standard mass chromatogram of a selected ion derived from the substance to be detected is stored beforehand in the database 406. A standard mass chromatogram 501 of a selected ion will now be described with reference to FIG. 5. In FIG. 5, time t and ionic strength (signal value) are plotted along an axis of abscissa 502 and an axis of ordinate 503, respectively. According to a data form of the standard mass chromatogram 501, time and a standard selected ion strength at the time are made one set and this set is stored as time series over an arbitrary time range (one data set corresponds to one point 504 in FIG. 5). As to an origin 505 of time, the time when the apparatus detected insertion of the wiping sheet is made an origin of time (t=0). It is preferable that a range 506 of time series, (spacing between start time and end time of standard chromatogram data), is provided over a range (about 15 seconds) which is at least longer than the measurement time (10 seconds in the case of this apparatus) in the actual apparatus operation. This is because processing for shortening the measurement time may be performed in a fitting process to be described later.

Next, a processing flow will be described with reference to FIG. 6. First, measurement is made in the mass spectrometric analyzer 203 and a mass spectrum is obtained every time the measurement is made (S601). Each mass spectrum includes an ion component falling under a pre-specified range of a mass-to-charge ratio (m/z) and it is stored in the memory 403. Next, the processor 402 calls mass spectra from the memory 403 as the time elapses and prepares measurement mass chromatograms for selected ions (S602).

In this embodiment, the standard mass chromatogram registered in the database is fitted to a measured mass chromatogram so that the degree of coincidence between the standard mass chromatogram and the measured mass chromatogram becomes high (S603).

This fitting process is required for the following reason. In an apparatus like the apparatus 200 wherein the test sample 104 is adhered to the wiping sheet 102 and is vaporized by a heater or the like, the vaporization speed of sample molecules differs depending on each sample due to unevenness of distribution of the sample molecules in the wiping sheet 102 and unevenness of temperature distribution when heating the sample. Consequently, even in the case of mass chromatograms derived from the same substance, a peak rising inclination may differ depending on the sample. The peak rising inclination also varies with the amount of sample molecules.

Secondly, when a lot of baggage are inspected in a short time for example in an airport, the measurement time allowed for one test sample is about 10 seconds at most. In such a case, as to a substance of a low vapor pressure, there is a fear that the measurement time may become insufficient and that the measurement may not even reach a peak top of mass chromatogram.

Thirdly, when baggage is wiped with the wiping sheet, components contained in the human sebum and various substances derived from articles of daily use adhere inevitably to the wiping sheet. Among these components there may be included a component which reacts with the substance to be detected, exerting an influence on the formation of ions of the substance to be detected. The mass chromatogram of a selected ion derived from the substance to be detected can also vary depending on whether the proportion of such a reactant is large or small.

The fitting process (S603) includes a first fitting (S604) and a second fitting (S605). As respective evaluation functions there are used two different functions α, β which will be described later. Fitting parameters, which are common to both fittings S604 and S605, are a parallel movement quantity 702 and an expansion/contraction quantity 703 relative to a time base 701 shown in FIG. 7. With these fitting parameters, the shape of a standard mass chromatogram 704 in the database 406 is optimized. By imparting the parallel movement quantity 702 relative to the time base 701 to the standard mass chromatogram 704, variations in the mass chromatogram shape caused by a heating timing lag for the test sample and unevenness in the heating temperature are absorbed, and by imparting the expansion/contraction quantity 703 relative to the time base 701 to the standard chromatogram 704, variations in the mass chromatogram shape caused by a difference in the amount of the substance to be detected and unevenness in the heating temperature are absorbed.

A description will be given first about the evaluation function α used in the first fitting S604 out of the two fitting processes S603. The function α is a guideline which represents to what degree the shape of a measured chromatogram of a certain selected ion is made coincident by fitting with the shape of the standard mass chromatogram of a selected ion registered in the database. The higher the degree of coincidence, the closer to zero the function α. FIG. 8 is a conceptual diagram of calculation of α. In the same figure, the number of times of measurement and a normalized ionic strength (signal value) are plotted along an axis of abscissa 801 and an axis of ordinate 802, respectively. Black points represent measured mass chromatograms of selected ions. A solid line 804 represents a standard mass chromatogram of a selected ion which has been subjected to deformation by fitting. A peak top value is “1” because each is normalized at the maximum value. ΔSi (delta Si) 805 represents a difference between a normalized signal value 806 in a measured mass chromatogram of a selected ion in an i^{th} measurement and a standard signal value 807 in a fitted standard mass chromatogram of the selected ion. The latter signal value 807 is obtained by interpolation.

The definition of α is shown in the following equation (1). The sum Σ in the equation (1) is taken at every measurement i.
α=(1/ΣWi)·Σ(Wi(ΔSi)²) (1)
As is seen from the equation (1), α takes a value obtained by square and addition of ΔSi 805 in FIG. 8 at every measurement i. Wi represents weight for the number of times of measurement i and ΔSi is calculated by the following equation (2):
ΔSi=(Si/Smax)−(S′i/S′max) (2)
In the equation (2), Si stands for a signal value (806 in FIG. 8) in i^{th} measurement (time t is assumed to be ti) and Smax stands for a maximum signal value in the measured mass chromatogram. S′max stands for a signal value (807 in FIG. 8) corresponding to time ti obtained by interpolation in a standard mass chromatogram which results from deformation, with use of the two fitting parameters shown in FIG. 7, of the standard mass chromatogram registered in the database. Further, S′max stands for a maximum ionic strength value in the standard mass chromatogram registered in the database.

Thus, the function α corresponds to a square error between the measured mass chromatogram 803 normalized by the maximum signal value Smax and the standard mass chromatogram 804 normalized by the maximum signal value S′max. Such a comparison between normalized data is important for the function α. This is because, by excluding information on signal strength by standardization, it is possible to compare features of mass chromatograms irrespective of the amount of the substance to be detected. The higher is the degree of coincidence between a measured mass chromatogram and a standard mass chromatogram of a selected ion, the smaller is the value of the function α which is a square error of the two.

The following description is now provided about a calculation procedure for the function α. First, (i) the weight Wi in the equation (1) is set at Wi=1 for each time of measurement i, that is, the weight Wi is not taken into account, and then fitting is performed in this state, allowing the standard mass chromatogram to be deformed (parallel movement and expansion or contraction relative to the time base) so that the value of the function α becomes the smallest. (ii) Once the amount of deformation which affords the minimum value of α is determined, the weight Wi in the equation (1) is changed depending on the number of times of measurement i while the amount of deformation is given to the standard chromatogram, that is, the weight Wi is taken into account and thereafter the value of the function a is calculated again. The value of α thus obtained is adopted as a final value. The weight Wi for each time of measurement may be set arbitrarily or may be made proportional to the signal-to-noise (S/N) ratio in the measurement i. As described above, when fitting a standard mass chromatogram of a selected ion to a measured mass chromatogram of the selected ion, the weight Wi is set at Wi=1 for each time of measurement and is thus excluded, thereby preventing the fitting from being dragged by the weight. The step (ii) may be omitted and in this case the value of α obtained in the step (i) is adopted as a final value.

Next, the following description is now provided about the second fitting (S605 in FIG. 6) which uses the evaluation function β.

First, the evaluation function β will be described with reference to FIG. 9. FIGS. 9A and 9B are measured mass chromatograms obtained by measurement. More specifically, they are measured mass chromatograms of two selected ions (mass-to-charge ratios m/z=m1, m2) derived from a common substance like 306b and 306b′ explained above in connection with FIG. 3. In FIG. 9, the axis of abscissa 903 represents the number of times of measurement. On the other hand, FIGS. 9D and 9E illustrate standard mass chromatogram data registered in the database 406, in which the axis of abscissa 907 represents time. The axis of ordinate 908 in these four graphs represents ionic strength.

A change 911 (FIG. 9C) with time of a measured signal ratio Ri of two selected ions is newly determined from measured mass chromatograms 909 and 910 (respective signal values in i^{th} measurement are assumed to be Si,m1 and Si,m2). Likewise, a change 914 (FIG. 9F) with time of a standard signal ratio R′i is determined from standard mass chromatograms 912 and 913 (respective signal values in i^{th} measurement are assumed to be S′i,m1 and S′i,m2) of two selected ions.

The function β is a guideline for showing a degree of coincidence, which is based on comparison like FIG. 9G, after fitting 915 is performed with respect to the change 911 with time of the measured signal ratio Ri and the change 914 with time of the standard signal ratio R′i. The higher the degree of coincidence, the closer to zero the function β. The function β is defined by the equation (3). The sum Σ in the equation (3) is taken for each time of measurement i.
β=(1/ΣWi)·Σ(Wi(log(Ri/R′i))²) (3)
In the equation (3), i stands for measurement count and Wi stands for weight for i^{th} measurement. In the equation (3), the reason why the ratio of the measured signal ratio Ri to the standard signal ratio R′i is determined and a log thereof is taken is that the values of both signal ratios are presumed to be large. The signal ratio Ri of two selected ions in i^{th} measurement is represented by the following equation (4):
Ri=Si,m1/Si,m2 (4)
The signal ratio Ri′ is obtained by deforming the standard mass chromatograms of two selected ions with use of the fitting parameters shown in FIG. 7, then determining, by interpolation, signal values (S′i,m1, S′i,m2) at time t=ti of the deformed standard mass chromatograms of two selected ions, and calculating a ratio of those signal values. It is represented by the following equation (5):
R′i=S′i,m1/S′i,m2 (5)
It is to be noted that in the function β signals are not normalized unlike the function α which is given by the equations (1) and (2).

In this embodiment, the function β thus defined is used as an evaluation function and fitting is performed in the same way as in the case of α. As shown in S605 in FIG. 6, first (i) the weight Wi is set at Wi=1 for each time of measurement i in the equation (3), that is, the weight Wi is not taken into account, and in this state there is performed fitting, thereby causing the standard signal ratio to be deformed (parallel movement and expansion or contraction relative to the time base) so that a signal ratio (“standard signal ratio” hereinafter) of two selected ions determined from standard mass chromatograms well coincides with a signal ratio (“measured signal ratio” hereinafter) of the two selected ions determined from measured mass chromatograms, (that is, in such a manner that the function β becomes the smallest). (ii) Once there is obtained a deformation quantity of the standard signal ratio which affords the smallest value of β, the weight Wi for each time of measurement i is changed, that is, the weight is taken into account, while keeping the deformation imparted to the standard signal ratio, then in this state the value of β is determined in accordance with the equations (3), (4) and (5) and is adopted as a final value of β. The value of the weight Wi may be given arbitrarily by the user or may be given in a form dependent on the signal-to-noise (S/N) ratio of one or both of two selected ions. The step (ii) may be omitted and in this case the value of β obtained in the step (i) is adopted as a final value.

By utilizing the function β, correlation between two arbitrary selected ions, i.e., information on the formation of two selected ions, can be included in the criterion.

According to the most basic way of thinking, two selected ions having a characteristic signal ratio (i.e., ion formation ratio) are provided from among plural selected ions (parent ion, fragment ion, and ions resulting from reaction of the substance to be detected with other substances) which are derived from the substance to be detected, and a check is made to see if the characteristic of signal ratio is recognized also in measured data.

Another effective way of use of the function β will now be described with reference to FIG. 10. Among selected ions derived from the substance to be detected there is included one whose mass chromatogram changes like a solid line 1001 in FIG. 10. The mass chromatogram indicated by a dotted line 1002 in the figure is of oxygen ion (mass-to-charge ratio m/z=32). As shown in FIG. 10, the selected ion mass chromatogram 1001 exhibits a sharp attenuation after a peak 1003. In this case, it is not because the substance to be detected vaporizes completely and is lost but because of a sharp attenuation like the dotted line 1002 of oxygen ion which is necessary for the selected ion producing reaction. Thus, the selected ion mass chromatogram 1001, after its peak 1003, exhibits a strong correlation with the mass chromatogram 1002 of oxygen ion. By using the function β it is possible to digitize this correlation and use it as a criterion. Although in connection with FIG. 10 a description has been given about the correlation between selected ion and oxygen ion, it goes without saying that there is a case where it is better to take correlation with a substance other than oxygen ion. A selected ion strongly correlated with a selected ion concerned can be adopted.

Next, as shown in S606 in FIG. 6, a correction coefficient G is determined from the values of α and β thus obtained.

In the case where there are two selected ions derived from the substance to be detected, the simplest function form of G is the following equation (6):
G=(α₁ˆp₁)·(α₂ˆp₂)·(β₁₂ˆq₁₂) (6)
Where, α₁ and α₂ stand for α values of selected ions 1 and 2, respectively, and β₁₂ stands for β values calculated from the selected ions 1 and 2. Further, ˆ(hat) stands for power. The coefficients p₁, p₂ and q₁₂ are usually positive real numbers not including zero, and specify respective weights of α and β. Concrete coefficients p and q will now be described with reference to FIG. 11. FIG. 11A shows a relation between the mass-to-charge ratio (m/z) and the coefficient p and FIG. 11B shows a relation between sets of mass-to-charge ratio (m/z) and the coefficient q. This relation is set and stored in the database 406. It is not always necessary to define α and β for all masses and all mass sets. In this case, the values of p and q may also be undefined.

The better the coincidence is between measured mass chromatograms of two selected ions and standard mass chromatograms of the two selected ions, the smaller the values of α and β is. In this case, therefore, the correction coefficient G defined by the equation (6) also becomes smaller. The weight of α can be adjusted by changing the value of coefficient p in accordance with a selected ion. Likewise, the weight of β can be changed by changing the value of coefficient q in accordance with a combination of two selected ions. That is, for a threat which is a characteristic in the shape of mass chromatogram, the value of coefficient p is made large to increase the weight of α. On the other hand, for a threat which is characteristic in the correlation between a parent ion and a fragment ion decomposed from the parent ion, the value of coefficient q is made large to increase the weight of β.

The function form of the correction coefficient G is not limited to the above equation (6), but can be set freely to match the properties of the substance to be detected and the contents of database which the user possesses.

For example, as noted previously, among substances to be detected there are those affected by other chemical substances which are coexistent with the substances to be detected. In this case, the shape of a mass chromatogram(s) of one or plural selected ions derived from a substance to be detected may change greatly depending on whether the amount of another coexistent chemical substance is large or small. In such a case, several possible patterns of mass chromatograms of a selected ion are registered beforehand in a database and the degree of coincidence between respective standard mass chromatograms and measured mass chromatograms is determined using α and β.

In this case, the correction coefficient G is defined like the following equation (7):
G=min(αI, αII) (7)
Where, min( ) stands for a function of returning the smaller value of the parenthesized αI and αII. αI stands for the degree of coincidence between a measured mass chromatogram of a certain selected ion and a standard mass chromatogram I of the selected ion registered in the database. αII stands for the degree of coincidence between a measured mass chromatogram of the selected ion and a standard mass chromatogram II of the selected ion registered in the database. Like the equation (7), β need not be used if the use thereof is not necessary. Likewise, α need not be used if the use thereof is not necessary, and G may be calculated with β alone.

Conversely, a mass chromatogram derived from a substance not to be detected may be registered in the database. In this case, it should be considered that the better is the degree of coincidence of a measured mass chromatogram of a selected ion with the mass chromatogram derived from the substance not to be detected, the lower is the possibility of the test sample being the substance to be detected. This can be expressed by defining the function G like the following equation (8). Assuming that p>0 and q>0:
F=(αIˆp)·(αIIˆ−q) (8)
Where, αI stands for the value of a which represents the degree of coincidence between a measured mass chromatogram and a standard mass chromatogram derived from a substance to be detected and αII stands for the value of α which represents the degree of coincidence between the measured mass chromatogram and a standard mass chromatogram derived from a substance not to be detected. Since p>0 and q>0, if the measured mass chromatogram is closer to the standard mass chromatogram derived from the substance not to be detected, αI is large and αII is small, therefore, the correction coefficient G becomes large. Conversely, if the measured mass chromatogram is closer to the standard mass chromatogram derived from the substance to be detected, αI is small and αII is large, therefore, the correction coefficient G becomes small as a whole.

In this embodiment, the correction coefficient G is determined as above, thereafter, as shown in S607 and S608 in FIG. 6 and in the following equation (9), a mean signal value Sav is divided by the correction coefficient G and the resulting quotient Z is used as a final evaluation value, then on the basis of whether the evaluation value Z is larger or smaller than a preset threshold value Zth, it is determined whether the substance to be detected has been detected or not.
Z=Sav/G (9)
If there are N number of selected ions derived from the substance to be detected, the following processing is performed. First, N number of correction coefficients Gj are determined (j stands for the number of each selected ion, j=1, 2, . . . N) and a mean signal value Sav, j in the mass chromatogram of each selected ion is divided by the associated correction coefficient Gj to determine an evaluation value Zj in each selected ion. Next, with respect to selected ions derived from the substance to be detected (e.g., trinitrotoluene), if the respective evaluation values Zj obtained in advance are all larger than a preset threshold value Zth, j, it is regarded that the substance to be detected was detected (S609). Conversely, with respect to all the selected ions derived from the substance to be detected, if even one of the respective evaluation values Zj is smaller than the threshold value Zth, j, the substance to be detected is regarded as not having been detected (S610).

The correction coefficients Gj for selected ions may have different function forms to match the properties of the substance to be detected. In this case, function forms of the correction coefficients Gj are provided beforehand in terms of a program.

The effect of this embodiment will now be described with reference to FIG. 12. FIG. 12 compares between the state before application of this embodiment (FIG. 12A) and the state after application of this embodiment (FIG. 12B) with respect to one substance which exhibits a characteristic mass chromatogram in the detection of a threat. In each graph, an axis of abscissa 1103 represents the amount of the substance (unit: ng (nano gram)). The axis of ordinate in FIG. 12A represents a maximum signal value in mass chromatogram, while the axis of ordinate in FIG. 12B represents the evaluation value Z. Since the evaluation value Z is a value obtained by dividing the mean signal value Sav by the correction coefficient G, it is of the same order as the maximum signal value in FIG. 12A. One point in each graph corresponds to one test sample. In FIGS. 12A and 12B, the right three columns (1105, 1106 and 1107) are of the case where the substance to be detected is made a test sample. The columns 1105, 1106, and 1107, represent the amounts of 1 ng, 4 ng, and 16 ng, respectively. It is seen that the maximum signal value increases as the amount increases.

On the other hand, the left two columns (1108 and 1109) in each graph correspond respectively to the wiping sheet with the object substance, i.e., the substance to be detected, not adhered thereto (1108) and a test sample with a substance adhered to the wiping sheet which substance is different in the feature of mass chromatogram from the object substance (1109).

It is seen that the difference between the substance to be detected (the right three columns) and the substance not to be detected (the left two columns) is more significant in FIG. 12B which shows the state after application of this embodiment than in FIG. 12A which shows the state before application of this embodiment. Particularly, the substance 1109 not to be detected which has a mass chromatogram feature different from that of the substance to be detected is smaller in the evaluation value Z in FIG. 12B after application of this embodiment than in FIG. 12A before application of this embodiment, thus proving that the application of this embodiment is effective.

According to this embodiment, as described above, the detection performance for the substance to be detected can be improved.

The threat as referred to herein is a generic term for explosive threats, flammable threats and substances which may exert a bad influence on the human body such as narcotic drugs, with no limitation made to the illustrated materials.

According to the present invention, it is possible to distinguish with high accuracy whether a measured mass chromatogram of a selected ion is derived from a substance to be detected or derived from any other substances not to be detected.

What is claimed is:

1. An apparatus for detecting threats which vaporizes a substance adhered to a wiping sheet, ionizes gas molecules of the substance, subjects the resulting ions to mass spectrometric analysis and detects whether a threatening component is contained or not in said adhered substance, wherein:
the apparatus has a database for storing standard mass chromatograms of a plurality of ions derived from a threat, and
a comparison is made between a measured mass chromatogram of a mass-to-charge ratio obtained from said adhered substance and a standard mass chromatogram of said mass-to-charge ratio after fitting of said standard mass chromatogram to determine the degree of coincidence between said measured mass chromatogram and said standard mass chromatogram.

2. An apparatus for detecting threats which vaporizes a substance adhered to a wiping sheet, ionizes gas molecules of the substance, subjects the resulting ions to mass spectrometric analysis and detects whether a threatening component is contained or not in said adhered substance, wherein:
the apparatus has a database for storing standard mass chromatograms of a plurality of ions derived from a threat, and
a comparison is made between a change over time of a measured signal ratio, the measured signal ratio being obtained by calculating a signal value ratio at every measurement between a first measured mass chromatogram of a first mass-to-charge ratio obtained from said adhered substance and a second measured mass chromatogram of a second mass-to-charge ratio obtained from said adhered substance, and a change over time of a standard signal ratio, the standard signal ratio being obtained by calculating a signal value ratio at every time between a first standard mass chromatogram of said first mass-to-charge ratio and a second standard mass chromatogram of said second mass-to-charge ratio.

3. An apparatus for detecting threats which vaporizes a substance adhered to a wiping sheet, ionizes gas molecules of the substance, subjects the resulting ions to mass spectroscopic analysis and detects whether a threatening component is contained or not in said adhered substance, characterized in that:
the apparatus has a database for storing standard mass chromatograms of a plurality of ions derived from a threat,
a comparison is made between a first measured mass chromatogram of a first mass-to-charge ratio obtained from said adhered substance and a first standard mass chromatogram of said first mass-to-charge ratio after fitting of the first standard mass chromatogram to determine the degree of coincidence between said measured mass chromatogram and said standard mass chromatogram, and
a comparison is made between a measured signal ratio, the measured signal ratio being obtained by calculating a signal value ratio at every measurement between said first measured mass chromatogram and a second measured mass chromatogram of a second mass-to-charge ratio obtained from said adhered substance, and a standard signal ratio, the standard signal ratio being obtained by calculating a signal value ratio at every time between said first standard mass chromatogram and a second standard mass chromatogram of said second mass-to-charge ratio.

4. The apparatus for detecting threats according to claim 1, wherein said fitting comprises a movement parallel to a time base of said standard mass chromatogram and expansion and contraction of said time base.

5. The apparatus for detecting threats according to claim 3, wherein said fitting comprises a movement parallel to a time base of said standard mass chromatogram and expansion and contraction of said time base.

6. A method for detecting threats which vaporizes a substance adhered to a wiping sheet, ionizes gas molecules of the substance, subjects the resulting ions to mass spectrometric analysis and detects whether a threatening component is contained or not in said adhered substance, the method comprising the steps of:
calling standard mass chromatograms of a plurality of ions stored in a database to a memory;
calculating measured mass chromatograms of a plurality of mass-to-charge ratios from mass spectra obtained from said adhered substance;
selecting a measured mass chromatogram of a specific mass-to-charge ratio from among said plurality of measured mass chromatograms; and
comparing said selected measured mass chromatogram with a standard mass chromatogram of said specific mass-to-charge ratio after a fitting process of said standard mass chromatogram.

7. A method for detecting threats which vaporizes a substance adhered to a wiping sheet, ionizes gas molecules of the substance, subjects the resulting ions to mass spectrometric analysis and detects whether a threatening component is contained or not in said adhered substance, the method comprising the steps of:
calling a plurality of standard mass chromatograms stored in a database to a memory;
calculating measured mass chromatograms of a plurality of mass-to-charge ratios from mass spectra obtained from said adhered substance;
selecting a first measured mass chromatogram of a first mass-to-charge ratio and a second measured mass chromatogram of a second mass-to-charge ratio from among said plurality of measured mass chromatograms;
selecting a first standard mass chromatogram of said first mass-to-charge ratio and a second standard mass chromatogram of said second mass-to-charge ratio from among said plurality of standard mass chromatograms;
calculating a change over time of a measured signal ratio from a ratio of signal values at every measurement between said first measured mass chromatogram and said second measured mass chromatogram;
calculating a change over time of a standard signal ratio from a ratio of signal values at every measurement between said first standard mass chromatogram and said second standard mass chromatogram; and
making a comparison between the change over time of said measured signal ratio and the change over time of said standard signal ratio.

8. A method for detecting threats which vaporizes a substance adhered to a wiping sheet, ionizes gas molecules of the substance, subjects the resulting ions to mass spectrometric analysis and detects whether a threatening component is contained or not in said adhered substance, the method comprising a first evaluation step including the steps of:
calling standard mass chromatograms of a plurality of ions stored in a database to a memory;
calculating measured mass chromatograms of a plurality of mass-to-charge ratios from mass spectra obtained from said adhered substance;
selecting a measured mass chromatogram of a specific mass-to-charge ratio from among said plurality of measured mass chromatograms, and
comparing said selected measured mass chromatogram with a standard mass chromatogram of said specific mass-to-charge ratio after a fitting process of said standard mass chromatogram;
a second evaluation step including the steps of:
selecting a first measured mass chromatogram of a first mass-to-charge ratio and a second measured mass chromatogram of a second mass-to-charge ratio from among said plurality of measured mass chromatograms;
selecting a first standard mass chromatogram of said first mass-to-charge ratio and a second standard mass chromatogram of said second mass-to-charge ratio from among said plurality of standard mass chromatograms;
calculating a change over time of a measured signal ratio from a ratio of signal values at every measurement between said first measured mass chromatogram and said second measured mass chromatogram;
calculating a change over time of a standard signal ratio from a ratio of signal values at every measurement between said first standard mass chromatogram and said second standard mass chromatogram; and
making a comparison between the change over time of said measured signal ratio and the change over time of said standard signal ratio.

9. The method for detecting threats according to claim 8, further comprising the step of determining the product of a first evaluation function in said first evaluation step and a second evaluation function in said second evaluation step, and wherein, with use of said product, it is determined whether said adhered substance contains a component of the threat or not.
